(19) United States
(12) Patent Application Publication
(10) Pub. No.: US 2005/0004806 A1
(43) Pub. Date: Jan. 6, 2005

(54) Automatic patent claim reader and computer-aided claim reading method

(76) Inventors: Dah-Chih Lin, Hsin-Chu (TW); Jeffrey Liou, Hsin-Chu (TW); Joseph Du, Hsin-Tien City (TW); Chia-Hui Lin, Hsin-Chu (TW); Shih-Wen Tu, Taipei (TW); Hsien_Ying Tseng, Pusin Township (TW); Chun Yi Chen, Ji-an Township (TW); Yueh-Ching Lee, Jhongli City (TW)

Correspondence Address: DUANE MORRIS, LLP;IP DEPARTMENT, ONE LIBERTY PLACE, PHILADELPHIA, PA, 19103-7396, US

(21) Appl. No.: 10/601,164

(22) Filed: Jun. 20, 2003

(51) Int. Cl. G06F 17/60

(52) U.S. Cl. 705/1

(57) ABSTRACT

A method of analyzing a claim in a patent or patent application is disclosed, comprising retrieving a patent claim which has been rendered into a format parsable by a computer program into a computer memory; parsing the claim into a set of discrete elements; categorizing each element in the set of elements according to a predetermined rule; and storing a set of categorized elements in a data store. A parsing program executable in a computer may be used to parse the patent claim and, optionally, to identify one or more keyword sets in the parsed claim. A rating program may also be used to assign a rating weight to each categorized element. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims.

### FIELD OF INVENTION

The present invention relates to analyzing patents for scope of claims.

### BACKGROUND OF THE INVENTION

Often, parties holding one or more patents or patent applications need to understand the competitive strengths and/or weaknesses of those patents or patent applications for a given context. The context may be strategic such as during business negotiations like licensing or tactical such as during product design.

It is therefore often necessary for a human being to read one or more patents or patent applications, analyze the patents or patent applications read, and then somehow relate the analysis to other patents, patent applications, products, and/or services.

Some methodologies for such analysis have been suggested in the prior art, including looking at how many times a patent has been cited by other patents and/or patent applications. This may be useful in certain circumstances but it does not provide a methodology for assessing the strength of the patent, i.e. the scope of its claims.

### BRIEF DESCRIPTION OF THE DRAWINGS

FIG. 1 is a schematic overview of an exemplary system;

FIGS. 2a and 2b are exemplars of patent claim structures;

FIG. 3 is an illustration of limitations in a claim which may be necessary and therefore surplus; and

FIG. 4 is a flowchart of an exemplary embodiment of a method of the present invention.

### DETAILED DESCRIPTION OF A PREFERRED EMBODIMENT

In general, throughout this description, if an item is described as implemented in software, it can equally well be implemented as hardware.

As used herein, “data” is either singular or plural, as the context requires.

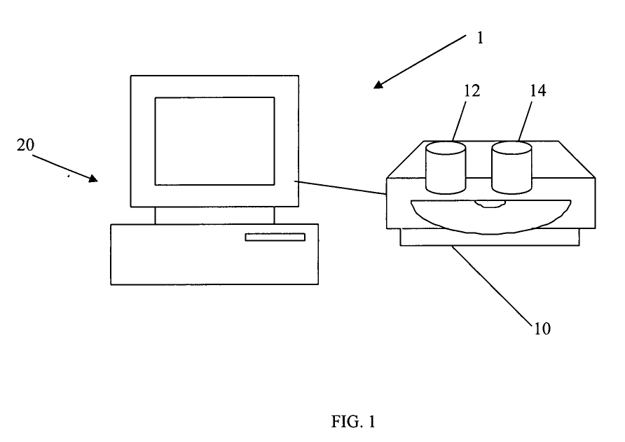

Referring now to FIG. 1, system 1 for patent analysis comprises data store 10, computer 20 operatively connected to data store 10, and parsing program 30 (not shown in the figures) executable in computer 20.

As used herein, data store 10 may be a persistent read/write data store such as a magnetic storage device, an electronic storage device, a hard drive or a rewritable optical medium, a persistent write-once-read-many data store such as a writable optical medium, a non-persistent data store such as random access memory, or the like, or a combination thereof.

As further used herein, computer 20 may be any suitable computer capable of being operatively connected to data store 10 and of executing parsing program 30, e.g. a personal computer.

Parsing program 30 is capable of parsing a patent claim into a set of discrete elements, categorizing each element in the set of discrete elements according to a predetermined rule, and storing a set of categorized elements in the data store. The claim may be made available to parsing program 30 in an electronic or optical or other equivalent format.

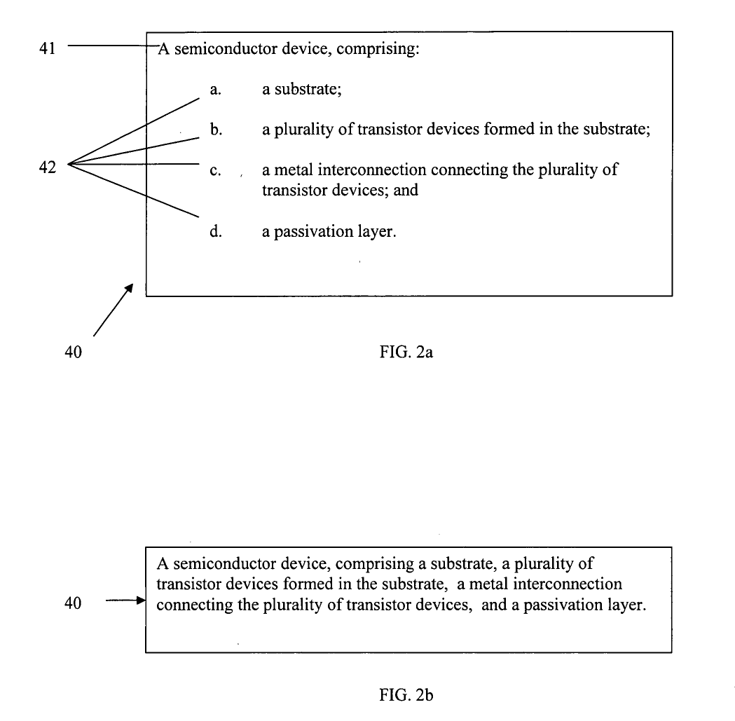

Referring now to FIG. 2a, patent claim 40 typically comprises preamble 41 and one or more elements 42.

Preambles are typically not used to limit elements 42. In certain drafting formats, a stylized format is used in which a prior art environment is first described, followed by the improvement to that prior art. This is sometimes referred to as a Jepson claim. Thus, preamble 41 to the Jepson claim clarifies necessary elements 42 which are not related to the strength of patent claim 40. Other times, preamble 41 merely sets a field for patent claim 40. However, at other times, preamble 41 may define a term, e.g. a member of a keyword set. Therefore, preamble 41 may need to be parsed to determine the scope of patent claim 40.

Element 42 further describes a limitation which, as will be familiar to those of ordinary skill in the patent drafting arts, further comprises structural and/or functional terminology. Typically, each element 42 is separated from other elements 42 by punctuation such as a semicolon. Further, each element 42 typically begins on a separate line from other elements. In some cases, each element is further numbered or otherwise identified as a separate element. Referring now to FIG. 2b, not all claims are written in the clean form illustrated in FIG. 2a. Often, patent drafts are faced with the question: 2b or not 2b?

Parsing program 30 may further be used to identify one or more keyword sets in a parsed claim. As used herein, a “keyword set” may comprise a noun, an adjective and a noun, a verb, an adverb and a verb, or the like. Keyword sets may be used for further analysis of each claim 40 and its preamble 41 and/or elements 42.

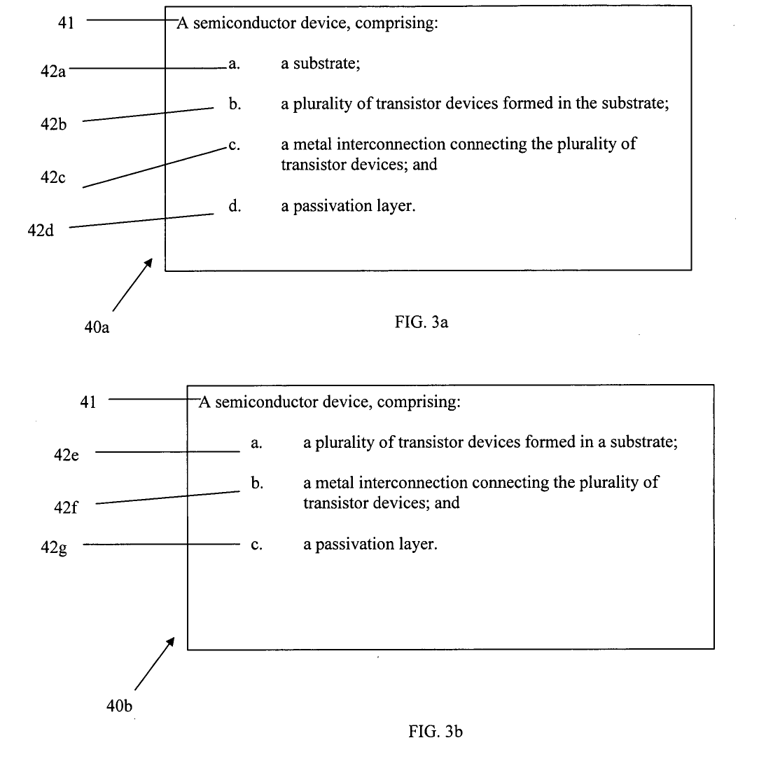

Referring now to FIG. 3a and FIG. 3b, additionally, not all elements 42 are meaningful to an analysis of claim 40. For example, claim 40a (FIG. 3a) claims a semiconductor device, element 42a of which is a substrate. Claim 40b (FIG. 3b) claims an equivalent semiconductor device which lacks a substrate element 42. However, the presence or absence of element 42a for the substrate does not impact the scope of coverage of claim 40b as substrates are necessary for semiconductor devices.

Accordingly, database 12 (FIG. 1) may be present to contain data and/or rules which allow parsing program 30 to identify, within a context of claim 40, those elements 42 which are necessary and therefore which do not affect the scope of claim 40. In a preferred embodiment, structural elements 42 may be analyzed using just the noun portion of that structural element 42 when identifying if that structural element 42 is necessary.

Elements 42 may additionally be logically paired with other elements 42. For example, “processing a photoresist layer” as an element 42 in a first claim 40 may be logically paired with elements 42 “applying a photoresist layer” and “removing the photoresist layer” for a semiconductor claim 40. Additionally, if a first claim 40 merely recites “removing the photoresist layer” as an element 42, that element 42 may be logically paired to elements 42 “applying a photoresist layer” and “removing the photoresist layer” for a second semiconductor claim 40.

Database 12 (FIG. 1), or, optionally, another database such as database 14 (FIG. 1), may contain a database comprising language equivalents useful to correlate a keyword set in a first expression to a keyword set in a second expression. For example, the correlation may relate a keyword set in English to one in Chinese, or may relate terms which are equivalent such as “RAM” with “random access memory” in a computer context. As another example, as an MOS transistor gate oxide is typically thermally grown on a substrate, the verb “formed” may be an equivalent to “thermally grown” for a claim involving an MOS transistor.

In a preferred embodiment, rating program 32 (not shown in the figures) is also present and executable in computer 20 (FIG. 1). Rating program 32 may be capable of assigning a rating weight to each categorized element 42 (FIG. 2a). Assignments of weights may be rules-based, e.g. a rule which takes into consideration the number of useful elements 42 and/or the scope of each element 42.

In the operation of an exemplary embodiment, a patent's claims may be analyzed for scope of coverage. Typically, a claim 40 (FIG. 2a) is stronger when it has a fewer number of elements 42 (FIG. 2a), or limitations. Further, typically, scope of claim 40 tends to weaken, e.g. become more narrow, with an increase in the number of elements 42 present in that claim 40. An analysis of a patent or patent application, e.g. a patent or application not owned by the analyzing party who wants to compare that patent or application against other patents or applications which may be owned or licensed by the analyzing party, may therefore consider the number of elements 42 present in each of the claims 40 to be analyzed and the scope of each of those elements 42, e.g. according to the meaning of the wording used for those elements 42.

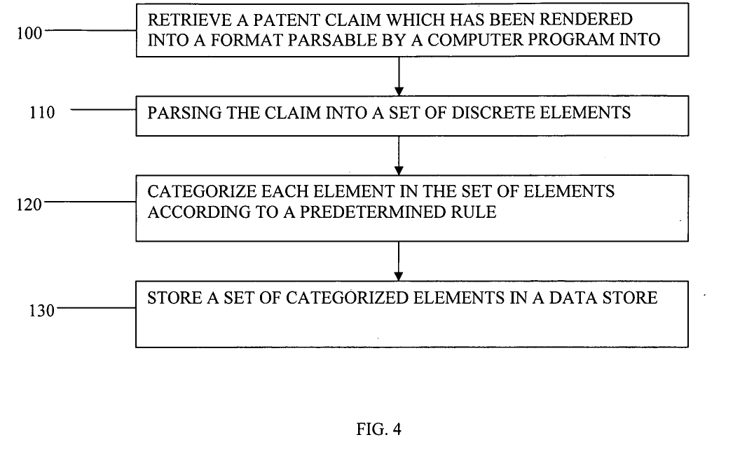

Referring now to FIG. 4, in an exemplary embodiment, claim 40 (FIG. 2a) is retrieved step 100, where claim 40 has been rendered into a format parsable by parsing program 20 (FIG. 2a) into a computer memory, e.g. data store 10 (FIG. 2a). Once retrieved, parsing program 20 may parse claim 40, step 110, into a set of discrete elements 42.

As used herein, parsing may be by semantic indexing, latent semantic indexing, rules based parsing, free form parsing, or the like, or a combination thereof. For example, parsing may further comprise using synonyms or equivalents from database 12,14 (FIG. 3).

In a preferred embodiment, parsing may further comprise identifying each keyword set in each element 42 where the keyword set comprises a noun, an adjective and a noun, a verb, an adverb and a verb, or the like. For example, nouns are typically present in structural elements 42 and verbs typically present in functional elements 42.

By way of example, in FIG. 2a, the following may be keyword sets that have been parsed: (1) substrate, (2) transistor devices, (3) metal interconnection, and (4) passivation layer.

Each keyword set may be analyzed to associate a modifier with the keyword set to categorize the keyword set, step 120. As used herein, a “modifier” may be a modifier identifying the keyword set as a necessary keyword set, a modifier identifying the keyword set as a non-necessary keyword set, or the like. During further analysis, keyword sets with a necessary modifier may be given less weight than other keyword sets for a claim 40. By way of example, in FIG. 2a, substrate may be associated with a “necessary” modifier and transistor devices, metal interconnection, and passivation layer associated with a “non-necessary” modifier.

As described herein above, a predetermined number of keyword sets may be logically paired with at least one other keyword set, e.g. if a first claim 40 merely recites “removing the photoresist layer” as an element 42, that element 42 may be logically paired to elements 42 “applying a photoresist layer” and “removing the photoresist layer” for a second semiconductor claim 40.

Parsing program 20 may categorize each element 42 in the set of elements according to a predetermined rule. For example, a categorization attribute may be associated with an element 42 such as a necessary attribute, a non-necessary attribute, a useful attribute, a non-useful attribute, a correlation attribute, or the like, or a combination thereof. As used herein, “necessary” means that this element 42 is assumed to be part of each claim of like type, e.g. all semiconductor transistor devices comprise a substrate. A “non-necessary” attribute may mean the opposite, e.g. this is novel or otherwise not always present in such claimed material. “Useful” may mean that this element 42 helps to distinguish its claim 40 over other patents, and “non-useful” may mean the opposite. “Correlation” may mean that this element 42 may be correlated to another element 42, e.g. a synonym from database 12,14.

As will be understood by those of ordinary skill in the computer arts, the modifiers, attributes, and logical pairings may be accomplished in a variety of equivalent ways, e.g. a field in a database record, an element in an array, use of different tables, and the like, or a combination thereof.

Additionally, parsed and categorized elements 42 may be assigned a rating weight to each categorized element. In certain embodiments, an element 42 which is modified such as with a numerical adjective is considered weaker than that element 42 without such a numerical adjective, e.g. “a transistor device” is stronger than “a plurality of transistor devices” which is stronger than “three transistor devices” for purposes of analysis of scope.

Rating may also take into consideration the number of useful and non-useful elements as well as the scope of each element. By way of example and not limitation, a rating may be obtained using a rule such as:

$$Rating = {\sum }_{i = 1}^{N} [ ( {Element}_{i} ) \times ( GSWeighting ) \times ( NumericalWeighting ) ]$$

where:
   Elementᵢ is a weight for the i^{th} element 42 of N elements 42, e.g. “1” for a useful element and “0” for a necessary element;
   GSWeighting is a factor which reflects the broad nature of the element, e.g. “1” for a genus claim, “2” for a species claim, “3” for a subspecies claim; and
   NumericalWeighting is a factor which reflects whether or not a numerical adjective is present for the i^{th} claim, e.g. “1” for no numerical adjective, “10” for the presence of a numerical adjective
      In such a weighting, a higher rating would reflect a claim having a narrower scope than a claim with a lower rating. This example is but one way to assign weights.

Categorizing may further comprise correlating each element 42 with at least one category in a database of categories, e.g. in database 12,14 (FIG. 1).

Analyzed claims 40 may be filtered, e.g. based on the categorized elements, such as by logically marking only those categorized elements 42 which meet a predetermined rule for the filtering. Such rules may include discarding those claims 40 which do not meet a predetermined rating weight, discarding those claims 40 which do not include predetermined language for an element 42, or the like, or a combination thereof.

Categorized elements 42, optionally filtered, may then be stored, step 130, e.g. in data store 10 such as in an interrogatable database.

In an embodiment, a target patent may be analyzed against a portfolio of patents. A portfolio of patents may be initialized in an interrogatable format, e.g. a computer manipulatable format. One or more patents may be selected from the portfolio of patents for analysis. A predetermined set of claims 40 of the selected patent may be parsed into a set of elements 42, e.g. by parsing program 30 and a rating generated for of each parsed claim 40 of the predetermined set of claims 40 of the selected patent using a predetermined weighting rule.

The rating such as by rating program 32 may generated according to a database of functions. If desired, rated claims 40 may be sorted according to a rate sorting rule such as a sort based on a rating and on a number of elements 42 present in each claim 40 of the patent being analyzed, a sort based on a rating and on a number of elements 42 present in each claim 40 of the selected patent where the elements 42 are further marked as necessary or non-necessary, a sort based on a rating and on a number of elements 42 present in each claim 40 of the patent where the elements 42 are further marked as useful or non-useful, or the like, or a combination thereof.

Additionally, a predetermined rule may be used to identify a best claim 40 of the predetermined set of claims 40 of the patent, e.g. one with the broadest scope such as with the lowest rating.

It will be understood that various changes in the details, materials, and arrangements of the parts which have been described and illustrated above in order to explain the nature of this invention may be made by those skilled in the art without departing from the principle and scope of the invention as recited in the appended claims.

1. A method of analyzing a claim in a patent or patent application, comprising:
a. retrieving a patent claim which has been rendered into a format parsable by a computer program into a computer memory;
b. parsing the claim into a set of discrete elements;
c. categorizing each element in the set of elements according to a predetermined rule; and
d. storing a set of categorized elements in a data store.

2. The method of claim 1, wherein:
a. parsing further comprises at least one of (i) semantic indexing, (ii) latent semantic indexing, (iii) rules based parsing, or (iv) free form parsing.

3. The method of claim 1, wherein parsing further comprises:
a. identifying each keyword set in each element, the keyword set comprising at least one of (i) a noun, (ii) an adjective and a noun, (iii) a verb, or (iv) an adverb and a verb.

4. The method of claim 3, wherein:
a. each keyword set further comprises a modifier to categorize the keyword set, the modifier comprising at least one of (i) a modifier identifying the keyword set as a necessary keyword set or (ii) a modifier identifying the keyword set as a non-necessary keyword set.

5. The method of claim 3, wherein:
a. the stored set of categorized elements is stored an interrogatable database.

6. The method of claim 5, wherein:
a. the categorization attribute is at last one of (i) a necessary attribute, (ii) a non-necessary attribute, (iii) a useful attribute, (iv) a non-useful attribute, or (v) a correlation attribute.

7. The method of claim 3, wherein:
a. a predetermined number of keyword sets are logically paired with at least one other keyword set.

8. The method of claim 1, wherein:
a. categorizing further comprises correlating each element with at least one category in a database of categories.

9. The method of claim 1, further comprising:
a. assigning a rating weight to each categorized element.

10. The method of claim 1, further comprising:
a. filtering a claim based on the categorized elements, filtering further comprising logically marking only those categorized elements which meet a predetermined rule for the filtering.

11. A method of analyzing a patent against a portfolio of patents, comprising:
a. initializing a portfolio of patents in an interrogatable format;
b. selecting a patent from the portfolio of patents for analysis;
c. parsing each of a predetermined set of claims of the selected patent into a set of elements; and
d. generating a rating of each parsed claim of the predetermined set of claims of the selected patent using a predetermined weighting rule.

12. The method of claim 11, wherein:
a. the rating is generated according to a database of functions.

13. The method of claim 11, further comprising:
a. using a predetermined rule to identify a best claim of the predetermined set of claims of the patent.

14. The method of claim 11, further comprising:
a. sorting the rated claims according to a rate sorting rule.

15. The method of claim 14, wherein:
a. the rate sorting rule comprises at least one of (i) a sort based on a rating and on a number of elements present in each claim of the patent, (ii) a sort based on a rating and on a number of elements present in each claim of the selected patent where the elements are further marked as necessary or non-necessary, or (iii) a sort based on a rating and on a number of elements present in each claim of the patent where the elements are further marked as useful or non-useful.

16. The method of claim 11, wherein:
a. patents comprises issued patents and patent applications.

17. A system for patent analysis, comprising:
a. a data store;
b. a computer operatively connected to the data store; and
c. a parsing program executable in the computer, the parsing program capable of parsing a patent claim into a set of discrete elements, categorizing each element in the set of discrete elements according to a predetermined rule, and storing a set of categorized elements in the data store.

18. The system of claim 17, further comprising:
a. a rating program executable in the computer, the rating program capable of assigning a rating weight to each categorized element.

19. The system of claim 17, wherein:
a. the parsing program is further useful to identify one or more keyword sets in the parsed claim, the keyword set comprising at least one of (i) a noun, (ii) an adjective and a noun, (iii) a verb, or (iv) an adverb and a verb.

20. The system of claim 19, further comprising:
a. a database of language equivalents useful to correlate a keyword set in a first expression to a keyword set in a second expression.
